(19) United States
(12) Patent Application Publication
(10) Pub. No.: US 2005/0086814 A1
(43) Pub. Date: Apr. 28, 2005

(54) Cutter of juicer

(76) Inventor: Hsin-Fu Huang, Taoyuan Hsien (TW)

Correspondence Address: SUPREME PATENT SERVICES, POST OFFICE BOX 2339, SARATOGA, CA, 95070, US

(21) Appl. No.: 10/695,032

(22) Filed: Oct. 27, 2003

(51) Int. Cl. B26B 3/00

(52) U.S. Cl. 30/302

(57) ABSTRACT

A cutter of juicer includes three arcuate blades arranged in equiangular positions and at different horizontal levels. Each blade has a convex side forming a plurality of serrate knife teeth for reaming foods rapidly when the blades rotate.

### BACKGROUND OF THE INVENTION

1. Field of the Invention

The present invention relates to a cutter disposed on a bottom end of a container of a juicer for reaming foods.

2. The Prior Arts

An average juicer is usually provided with a container on a base, in which a cutter is fixed on the base and in the container; and a motor having its central shaft connected with the cutter is disposed in the base. When the motor is powered, the cutter is driven to rotate and ream food in the container.

In the structure of a conventional cutter of a juicer, a blade is arranged on two opposite sides of the central shaft respectively. Since those two blades mounted on the central shaft are positioned at the same height level, irrespective of their shapes, either straight or curved, when reaming food, in addition to their simple configuration, the blades always irritate and crush the food only along the same path at the same height level, which is considered lack of efficiency and in need of a longer time to complete the crush job.

### SUMMARY OF THE INVENTION

The primary object of the present invention is to provide an improved cutter of juicer with a better working efficiency than a conventional one, when working under a same rotation speed.

A secondary object of the present invention is to provide an improved cutter of juicer with a better working efficiency, by which saving power to obtain economic benefit is possible.

In order to realize mentioned objects, the juicer cutter in accordance with the present invention is constructed by distributing three arcuate blades in equiangular positions and at different horizontal levels, in which each blade is provided at a convex side thereof with a plurality of serrate knife teeth for reaming foods rapidly when the blades are driven to rotate.

When compared with a conventional juicer cutter, the juicer cutter of the present invention would present a better working efficiency in reaming foods because of the arcuate blades spaced in equiangular positions in a circle to therefore secure an excellent balance feeling and the serrate knife teeth thereof.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a perspective view of a juicer cutter constructed in accordance with the present invention;

FIG. 2A is a top plane view of the juicer cutter of the present invention;

FIG. 2B is a side elevational view of the juicer cutter of the present invention;

FIG. 3A is a plane view of a first blade of the juicer cutter of the present invention;

FIG. 3B is a plane view of a second blade of the juicer cutter of the present invention; and

FIG. 3C is a plane view of a third blade of the juicer cutter of the present invention.

### DETAILED DESCRIPTION OF THE PREFERRED EMBODIMENT

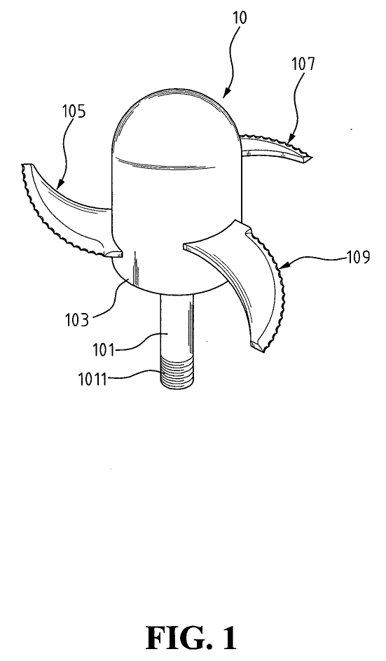

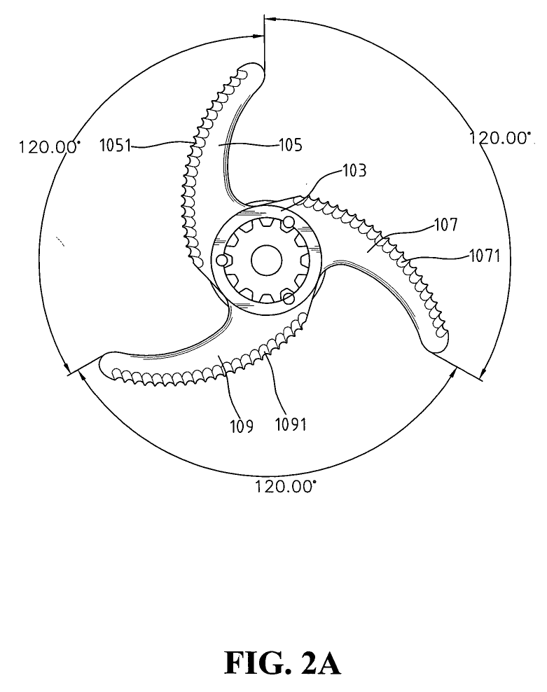

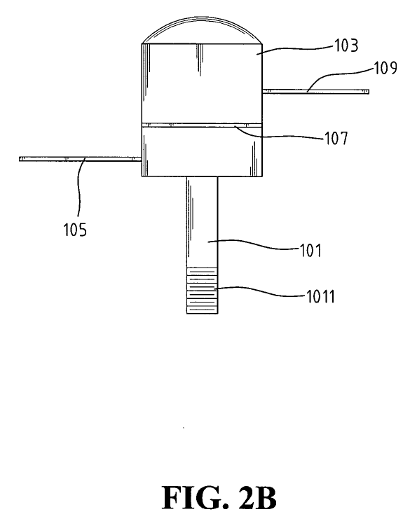

As shown in FIGS. 1, 2A, and 2B, a cutter 10 of juicer in accordance with the present invention comprises a head portion 103 fixed to a top end of a central shaft 101, in which an external thread 1011 is formed on a bottom end of the central shaft 101. A first blade 105, a second blade 107, and a third blade 109 that are shaped identically are fixed peripherally to the head portion 103 at different positions, namely, the first blade 105 at the lowest position, the second blade 107 at the second lowest, and the third blade 109 at the highest, so that the knife points of those three blades 105, 107, 109 move in an approximate helical locus. The blades 105, 107, 109 all are arc-shaped and provided at a convex side with a serrate knife-edge 1051, 1071, 1091, respectively. The external thread 1011 of the central shaft 101 is engageable with a motor of the juicer (not shown) for driving the blades 105, 107, 109.

When the juicer cutter of the present invention rotates, the blades 105, 107, 109 turn the food in a food container of the juicer over and over and crush the food effectively under assistance of the helical locus and the serrate knife-points of the moving blades to thereby save time and raise working efficiency significantly.

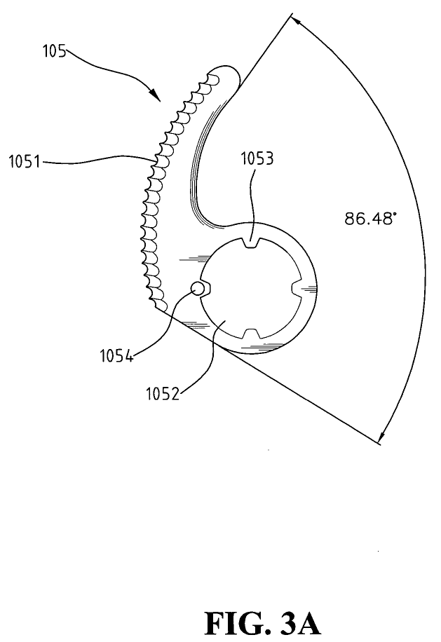

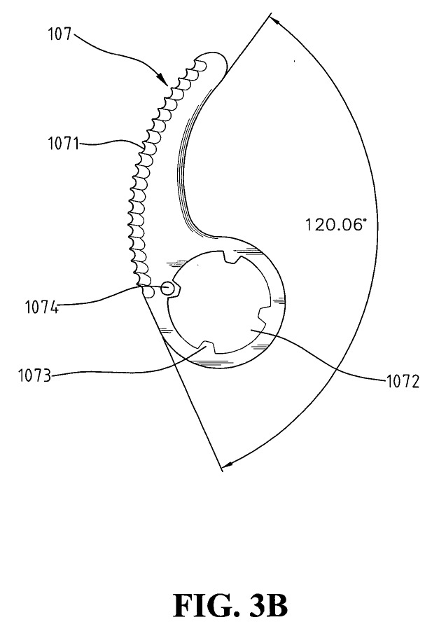

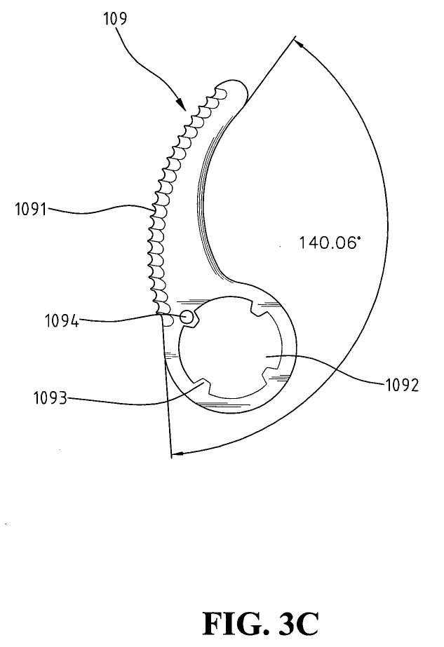

FIGS. 3A-3C show the structures of the blades 105, 107, 109. In the arc-shaped first blade 105, there is a central hole 1052 formed at one end of the blade 105, in which a plurality of protruding blocks 1053 is arranged on the inner circumference of the central hole 1052; a relatively small hole 1054 is formed in a specified protruding block 1053; a convex arcuate side of the first blade is provided with a plurality of serrate knife-teeth; and an included angle of 86.48° is contained between the back and the tail end of the blade (105).

The second blade 107 is also arc-shaped and is generally identical to the first blade 105. The second blade 107 has a central hole 1072 formed at one end thereof, a plurality of protruding blocks 1073 arranged on an inner circumference of the central hole 1072, a relatively small hole 1074 formed in a specified protruding block 1073, a plurality of serrate knife-teeth formed on a convex arcuate side thereof, and an included angle of 120.06° contained between the back and the tail end thereof.

The third blade 109 is also arc-shaped and is generally identical to the first and second blades 105, 107. The third blade 109 has a central hole 1092 formed at one end thereof, a plurality of protruding blocks 1093 arranged on an inner circumference of the central hole 1092, a relatively small hole 1094 formed in a specified protruding block 1093, a plurality of serrate knife-teeth formed on a convex arcuate side thereof, and an included angle of 140.06° contained between the back and the tail end thereof.

The first, second, third blades 105, 107, 109 and the central shaft 101 are assembled by spacing three pieces of positioning pins in equiangular positions (120°) uniformly in molds for forming the head portion 103, then setting the first, second, and third blades 105, 107, 109 into the molds in the manner that the small holes 1054, 1074, 1094 in the respective blades 105, 107, 109 are penetrated through and positioned by those three positioning pins, then putting the top end of the central shaft 101 in the molds too, and injecting with a plastic material to form the head portion 103 and meanwhile, allowing the material to enter the space among the protruding blocks 1053, 1073, 1093 in the central holes 1052, 1072, 1092 of the blades 105, 107, 109 to combine them together, also with the central shaft 101, to complete the assembly of the juicer cutter 10 of the present invention.

In the above described, at least one preferred embodiment has been described in detail with reference to the drawings annexed, and it is apparent that numerous changes or modifications may be made without departing from the true sprit and scope thereof, as set forth in the claims below.

1. A cutter of juicer comprising three arcuate blades mounted to a central shaft peripherally, wherein the blades are separately attached to the shaft at different height levels and distributed in equiangular positions, a convex side of each blade forming a serrate knife edge.

2. The cutter of juicer according to claim 1, wherein each blade is attached to the central shaft horizontally.
